(19) United States
(12) Patent Application Publication
(10) Pub. No.: US 2024/0193978 A1
(43) Pub. Date: Jun. 13, 2024

(54) DOCUMENT IMAGE TEMPLATE MATCHING

(71) Applicant: INTERNATIONAL BUSINESS MACHINES CORPORATION, Armonk, NY (US)

(72) Inventors: Ang Yi, Beijing (CN); Jing Zhang, Beijing (CN); Hai Cheng Wang, Beijing (CN); Jun Hong Zhao, ShangDi (CN); Rajesh M. Desai, San Jose, CA (US); Yang Zhong Li, Beijing (CN); Ye Chen, Beijing (CN)

(21) Appl. No.: 18/065,352

(22) Filed: Dec. 13, 2022

(51) Int. Cl. G06V 30/412; G06V 10/26; G06V 10/74; G06V 10/75; G06V 30/413; G06V 30/414

(52) U.S. Cl. CPC G06V 30/412; G06V 10/273; G06V 10/751; G06V 10/761; G06V 30/413; G06V 30/414

(57) ABSTRACT

Computer implemented methods, systems, and computer program products include program code executing on a processor(s) that merges a document comprising multiple pages into a single document image. The program code processes the single document image to identify structural elements and textual content. The program code compares the structural elements of the single document image to other structural elements of a group of document templates stored in a database to identify a subset of the group of documents templates with a threshold number of similarities to the single document image. The program code generates, from the single document image, a graph structure representing the document, where the graph structure comprises visual information and connections related to the structural elements and concepts comprising the textual content. The program code uses the structure to identify a document template that is a closest match to the document.

### BACKGROUND

The present invention relates generally to the field of automated document processing and more particularly to image processing for base template recognition.

Template Matching is a high-level machine vision technique that identifies parts in an image that matches a predefined template. Template Matching is a method for searching and finding a location of a template image in a larger image by finding similar templates in a source image by giving a base template image to use in a comparison. Template matching is utilized for object detection projects, like product quality, vehicle tracking, robotics etc. Traditionally, template matching is accomplished by comparing each pixel value of a source image to the template image. The output would be an array of similarity values when each pixel is compared to the template image.

One type of Template Matching is Document-Image Template Matching (Doc-Image Template Matching). In Doc-Image Template Matching, program code executing on at least one processor utilizes base template matching to detect related fields in a document image. In automated document processing, the program code identifies a document type of a document by comparing a base document template to the document and extracting related fields in document images. In some existing Doc-Image Template Matching, the program code utilizes image hashing to compare the document to the base template. Image hashing is the process of using an algorithm to assign a unique hash value to an image. Duplicate copies of the image all have the exact same hash value, which can also be referred to as a digital fingerprint.

### SUMMARY

Shortcomings of the prior art are overcome, and additional advantages are provided through the provision of a computer-implemented method for improving template matching in a document-image. The computer-implemented method includes: merging, by one or more processors, a document comprising multiple pages into a single document image; processing, by the one or more processors, the document image to identify structural elements and textual content comprising the structural elements; comparing, by the one or more processors, the structural elements of the single document image to structural elements of a group of document templates stored in a database and based on the comparing, identifying a subset of the group of documents templates with a threshold number of similarities to the single document image; generating, by the one or more processors, from the single document image, a graph structure representing the document, wherein the graph structure comprises visual information and connections related to the structural elements and concepts comprising the textual content; and identifying, by the one or more processors, based on comparing the graph structure to the subset of the group of documents templates, a document template that is a closest match to the document.

Shortcomings of the prior art are overcome, and additional advantages are provided through the provision of a computer program product for improving template matching in a document-image. The computer program product comprises a storage medium readable by a one or more processors and storing instructions for execution by the one or more processors for performing a method. The method includes, for instance: merging, by the one or more processors, a document comprising multiple pages into a single document image; processing, by the one or more processors, the document image to identify structural elements and textual content comprising the structural elements; comparing, by the one or more processors, the structural elements of the single document image to structural elements of a group of document templates stored in a database and based on the comparing, identifying a subset of the group of documents templates with a threshold number of similarities to the single document image; generating, by the one or more processors, from the single document image, a graph structure representing the document, wherein the graph structure comprises visual information and connections related to the structural elements and concepts comprising the textual content; and identifying, by the one or more processors, based on comparing the graph structure to the subset of the group of documents templates, a document template that is a closest match to the document.

Shortcomings of the prior art are overcome, and additional advantages are provided through the provision of a system for improving template matching in a document-image. The system includes: a memory, one or more processors in communication with the memory, and program instructions executable by the one or more processors via the memory to perform a method. The method includes, for instance: merging, by the one or more processors, a document comprising multiple pages into a single document image; processing, by the one or more processors, the document image to identify structural elements and textual content comprising the structural elements; comparing, by the one or more processors, the structural elements of the single document image to structural elements of a group of document templates stored in a database and based on the comparing, identifying a subset of the group of documents templates with a threshold number of similarities to the single document image; generating, by the one or more processors, from the single document image, a graph structure representing the document, wherein the graph structure comprises visual information and connections related to the structural elements and concepts comprising the textual content; and identifying, by the one or more processors, based on comparing the graph structure to the subset of the group of documents templates, a document template that is a closest match to the document.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a workflow that illustrates various aspects of some embodiments of the present invention;

FIG. 3 is a workflow that illustrates various aspects of some embodiments of the present invention;

FIG. 4 is an illustration of a structure generated by the program code in some embodiments of the present invention;

FIG. 5 is a workflow that illustrates various aspects of some embodiments of the present invention;

FIG. 6 is an illustration of certain elements analyzed by the program code in some embodiments of the present invention;

FIG. 7 is a workflow that illustrates various aspects of some embodiments of the present invention; and

FIG. 8 is a workflow that illustrates various aspects of some embodiments of the present invention.

### DETAILED DESCRIPTION

The examples described herein provide a method, system, and computer program product, where program code executing on one or more processors precisely locates a matched base template by comparing documents using knowledge graphs that the program code builds on the fly. The program code generates knowledge graphs that integrate visual and structural information with textual information to improve the accuracy of field template matching in a document-image. As will be discussed, the examples herein provide significant advantages in Doc-Image Template Matching, which is a type of automated document processing.

Business documents are images of structured documents or fixed forms taken from a physical scanner and processed on a daily basis. Doc-Image Template Matching is a form of automated document processing in which program code executing on one or more processors recognizes characteristics of base templates in business documents. There are various challenges when using present Doc-Image Template Matching techniques, which affect the accuracy of this automated processing. Some of these challenges amount to complexities in the documents themselves that affect the ability of the program code to match the documents to the base template. These challenges include, but are not limited to: 1) distorted and/or deformed regions (e.g., blocks or text areas) in the document image; 2) variation in the contents of a text block (e.g., in a name of a person or entity, a variation in postal address such as an address in the different country, etc.); 3) an unexpected graphical element or signal of decodable indicia (e.g., a stamp, barcode, QR code, etc.); and/or 4) a variation in the length of a table and/or a text block spanning multi-pages.

Certain terms are used throughout this document when describing elements of a document image and/or of a graph-like structure generated from a document image by the program code in the examples herein. Within the context of this document, block types include, but are not limited to, document elements such as table blocks, barcode blocks, image blocks, signature blocks, and text blocks. Within the context of this document, graph nodes, e.g., nodes of a graph-like structure that the program code generate from a document image, include, but are not limited to, nodes in specific positions (upper block reference, down block reference, left block reference, right block reference), extractors (regular expression extractors, name entity recognition (NER) extractors), a block formulator, a block validator, a block type, and/or a block image hashing.

Embodiments of the present invention provide significantly more than existing Doc-Image Template Matching techniques. Program code in existing methods of Doc-Image Template Matching utilizes only visual information in the image for template comparison. Because these existing methods do not utilize document elements, including but not limited to text contents and structural information in a document, the accuracy of the Doc-Image Template Matching suffers. One general approach, which the examples herein improve upon (which is discussed in detail, herein) is a clip or crop approach wherein the program code clips or crops field images from a main document and use them as base field templates. The program code defines and/or tunes thresholds for different fields. The program code them applies template matching for each cropped base field template. The program code can draw bounding boxes using the coordinates of rectangles fetched from template matching. Even in cases where a runtime document was filled by a template, the program code utilizing this clip or crop approach can fail to match the document to this template because the document contains elements such as a table of a different length than the template, a barcode, QR code, and/or stamp in a different position than in the template.

Rather than limit the analysis to visual information, the examples described herein provide improved Doc-Image Template Matching methods, systems, and computer program products, because the program code in these examples (executing on one or more processors) integrates visual and structural information with textual information in its analyses, thus, improving the accuracy of the field template matching performed by the program code.

Embodiments of the present invention provide significantly more than existing automated document analysis techniques. Unlike certain techniques which use textual analysis to break a boundary of a self-contained software program, program code in embodiments of the present invention mitigates and/or eliminates the influence of layout and/or block structure in a runtime document (e.g., block position shifted), and matches a structure of a template to the runtime document for the purpose of extracting information. Although other techniques can process searchable documents and leverage text-only information for document and component level classification, in embodiments of the present invention, the program code is not limited in this manner as it can process (more) image-based documents by leveraging the technology of image hashing to compare fingerprint templates. While other document processing technologies process each page of a document separately, as will be described in greater detail herein, the program code in some embodiments of the present invention can merge the pages of a document into a single image-based page and can utilize this single page to perform a comprehensive image analysis and comparison for the entirety of the document. Another limitation of some existing approaches is the classifier module in these approaches can only perform document level classification when all the components of the document have been classified. Aspects of certain of the examples herein take an inverse approach. Program code in these embodiments determines the document type of a given document by utilizing object detection. The program code can then match a template at a component level by utilizing an image hashing technology. This inverse approach increases efficiently, for example, when the program code processes two different types of documents (e.g., an identification card and an invoice).

Embodiments of the present invention are inextricably tied to computing and are directed to a practical application. Automated document processing is a challenge that is specific to computing. As will be discussed herein, the document processing herein combines artificial intelligence (AI) with deep learning and low-code tooling to help you eliminate manual document processing. In certain of the examples herein, program code executing on one or more processors classifies and extracts information from business documents more quickly, easily, and accurately than existing techniques. Aspects described herein are directed to a practical application at least because these aspects help an end user to improve the accuracy of classifications of documents by documents type, which increased the productivity of full document automatic lifecycles. The embodiments described herein are also inextricably linked to computing because the program code generates, in real-time, knowledge graphs that integrate visual and structural information with textual information to improve the accuracy of field template matching in a document-image. As will be described herein, the program code locates the matched base template of a given document by comparing the document to the template using these knowledge graphs.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

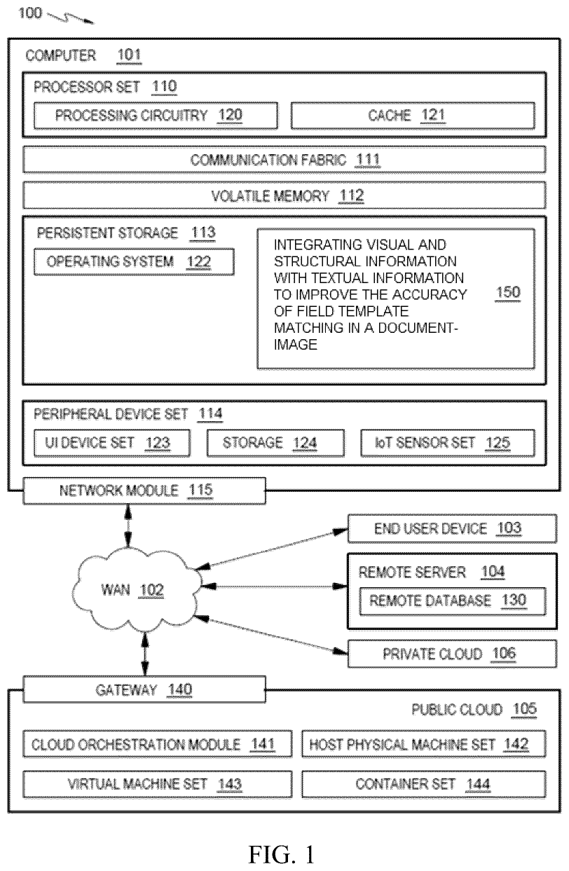

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as a code block for integrating visual and structural information with textual information to improve the accuracy of field template matching in a document-image 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

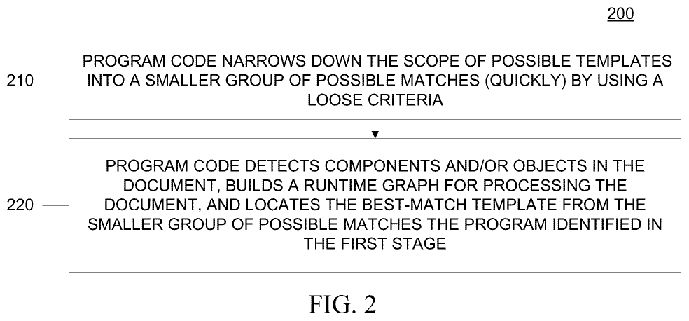

Embodiments of the present invention include method, computer program products, and systems where program code executing on one or more processors performs a method that integrates visual and structural information with textual information to improve the accuracy of field template matching in a document-image. FIG. 2 is an overview of a workflow 200 performed by program code in some embodiments of the present invention. In embodiments of the present invention, program code executing on one or more processors utilizes a graph-like structure to represent a business document. The graph-like structure is made up of two main components: nodes and edges. A node represents an object in a document, including but not limited to, a block and/or a layout object, and an edge defines a relationship between the nodes. Thus, the knowledge graph generated by the program code in embodiments of the present invention, stores the visual and the structural information of business document. Certain embodiments of the present invention comprise a two-stage document classifier comprising program code that locates a best-matched document template from one or more (e.g., including multiple) base templates. FIG. 2 provides an example of an overview of the workflow 200 of the program code comprising this classifier. As illustrated in FIG. 2, in a first stage, the program code narrows down the scope of possible templates into a smaller group of possible matches (quickly) by using a loose criteria (210). In a second stage, the program code detects components and/or objects in the document, builds a runtime graph for processing the document, and locates the best-match template from the smaller group of possible matches the program identified in the first stage (220). In some examples, the program code at a first classification stage classifies document images and determines possible document types by comparing and evaluating a distance between a document and templates in a knowledge graph resource, such as a database. Meanwhile, the program code of the second stage classifier calculates the similarity of graph-like structure between the document and the template that is in the stored knowledge graph resource. Although the first and second classifiers are discussed separately, this separation is not indicative of the location or module configuration of the computer code that executes the classifier functionalities. This separation is provided for ease of understanding and not to introduce any structural limitations.

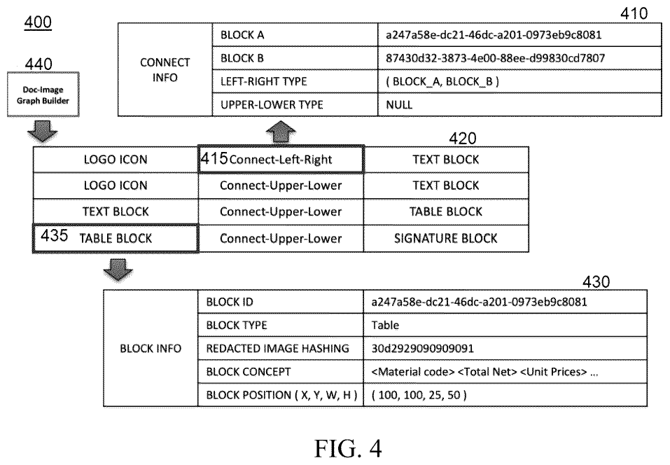

The program code can generate the contents of the knowledge graph database, over time. It is these contents that the program code will compare to a runtime document image, which the program code will convert to a graph-like image. To generate the templates, the program code can utilize an image pre-processor to process sample documents and store the results in a datastore. The program code can also store an edge rule composed in a datastore—the use of edges in comparisons of documents to templates is described in more detail herein. Some of the sample documents can be public domain sample documents. The program code discovers objects in the sample documents and generates the graph-like structures (e.g., FIG. 4). The program code stores the graph-like structure from the sample documents as templates in the knowledge graph database. During runtime, the program code can access the database to classify documents.

As will be described in greater detail herein, the program code executes a parallel system and method to calculate the similarity of nodes and edges between graph-like structures, which not only make the similarity measurable, but also enable scalable performance. To determine the similarities between a document and a template, the program code: 1) calculates a similarity of nodes and edges between graph-like structures; 2) determines an overall confidence for a base document template; and 3) performs a scalable confidence comparison between the document and the identified template.

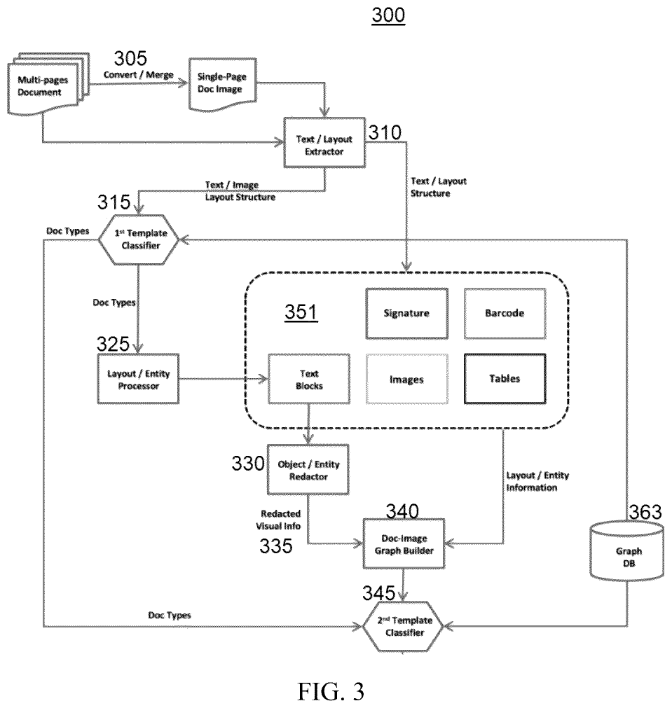

FIG. 3 is a more detailed workflow 300 that illustrates various aspects of the two-step classification process illustrated in FIG. 2. In some examples, herein, before the program code applies a two-stage classifier, the program code merges pages in a document into a single document image (also referred to as a full document image) (305). The program code processes this image to extract text and layout elements, including by performing optical character recognition (OCR) to recognize various items in the document (310). The program code can recognize, via OCR and other processing, segments, including but not limited to text segments and block segments. When performing the image processing, the program code can also recognize layout types 351, including but not limited to, logos, headers, titles, barcodes (or other signals of decodable indicia), tables, images, signatures, text, etc.

The program code proceeds to the first classifier stage (narrowing down the scope of possible templates into a smaller group of possible matches (quickly) by using a loose criteria, e.g., FIG. 2, 210) by classifying document images and determining possible document types by comparing and evaluating a distance between the document and templates in a knowledge graph database (315). The knowledge graph database 363 can contain historical template information. In making these comparisons between the document images and templates in a knowledge graph database, the program code utilizes an image hashing of the full document image (or digital fingerprint). The program code compares the structures and checks the block types (e.g., logo, table, barcode, etc.) as well as the quantity of each block type across the full document image against the templates in the knowledge graph database. The program code also compares the title and/or header of the full document image to templates in the knowledge graph database. Based on comparing, the program code identifies layout types in the document (325).

In the first classifier stage (FIG. 2, 210, FIG. 3, 315) the program code can utilize an image hashing algorithm (e.g., visual information) to determine a distance between an incoming document image and a base document template. For example, the image hash for a given invoice (document) can be 1bcbba1b618cc1e5, while the image hash for a second invoice is 9bd9b8884ece8de5. The program code can determine that these images (pictures) are different with a distance of 18. A goal of the first classifier stage is that the program code can quickly narrow down the possible templates that match a given document from a large number of base templates. Thus, in some examples, a user or administrator can configure a threshold of less than thirty templates as a number that the program code can match based on the analysis at the first classifier stage discussed herein.

Returning to FIG. 3, once the program code has identified layout blocks in the document, the program code processes these layout blocks (325). As part of processing the layout blocks, the program code: recognizes named entities, extracts concepts in texts in blocks, connects blocks based on their position in the document-image, and calculates the fingerprints of the blocks (e.g., image hashing etc.). Based on pre-configured requirements, the program code redacts various entities and/or texts from the document image (330). For example, the program code could redact items such as stamp components, currency, date, organization, person name, or location, etc. Based on the redactions, the program code calculates a visual fingerprints for the redacted blocks (335). The program code builds a graph-like structure for the document that it processed (340). To generate the graph, the program code utilizes the visual information e.g., image hashing of the blocks), the structural information (e.g., connected blocks), and textual information (e.g., concepts embodied in the blocks, which are the non-redacted entities). Once the program code has generated the graph-like structure, the program code referred to as the second stage classifier calculates the similarity of graph-like structure between document and template that is stored in graph database (345).

FIG. 4 is an example of a graph-like structure 400 that can be generated by program code in some examples herein. The values in FIG. 4 are provided for illustrative purposes only and not for the purpose of introducing any limitations. To generate the graph-like structure, as illustrated in FIG. 3, the program code (e.g., of the document image graph builder) has processed the image document (the multiple pages merged into a single image) to locate items including, but not limited to, logo icons, text blocks, table blocks, signature blocks, etc. The consolidated graph 420 includes both connection information 410 and block information 430. The graph-like structure 400 illustrates a closer view of block information for a given table block 435 and connection information 410 for a given connection, in this case, connect-left-right 415. The block information 430 includes a block identifier (e.g., a247a58e-dc21-46dc-a201-0973eb9c8081), a block type (e.g., table), a redacted image hashing (e.g., 30d22929090909091), a block concept, contextual information about the content of the text in the block (e.g., <Material code><Total Net><Unit Prices> . . . ), and a block position (using x, y, w, and h values) (e.g., (100, 100, 25, 50)). Meanwhile, the connection information 410 includes information about the connected blocks, Block A, the block for which the block information 430 refers, (e.g., a247a58e-dc21-46dc-a201-0973eb9c8081) and Block B (e.g., 87430d32-3873-4e00-88ee-d99830cd7807). The connection information 410 also includes the left-right type (e.g., BLOCK_A, BLOCK_B), and the upper-lower type (e.g., NULL). Thus, the graph structure stores elements of the various blocks that comprise a document image as well as the connections between these elements.

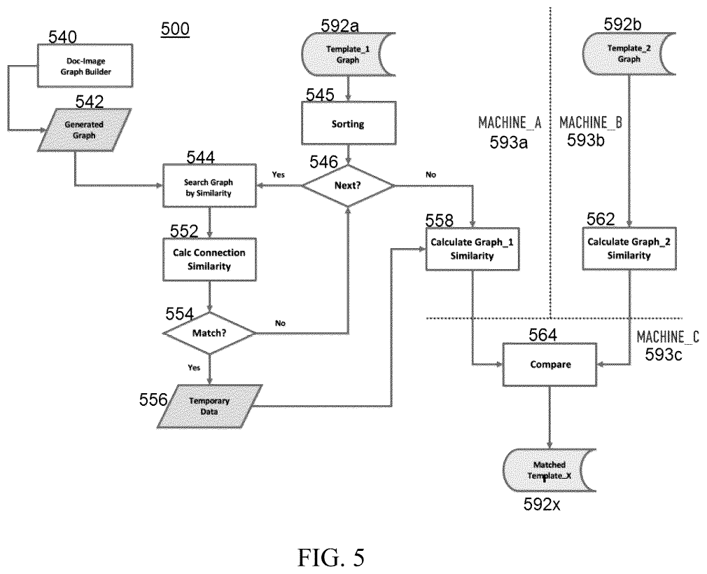

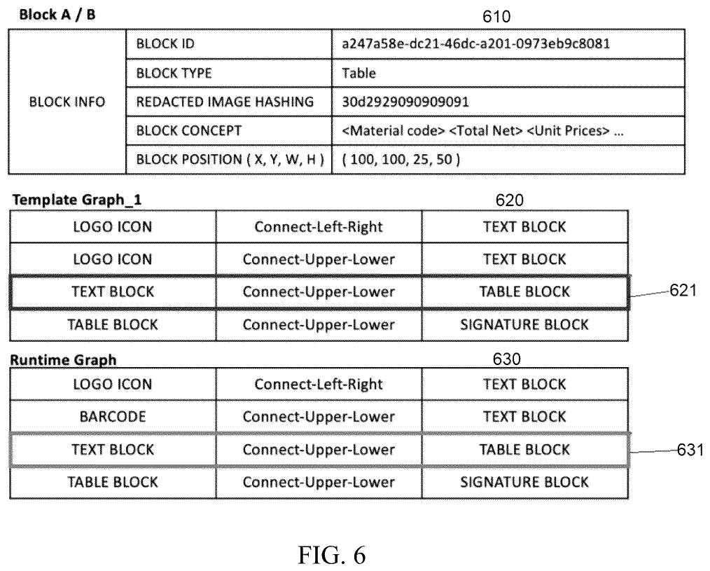

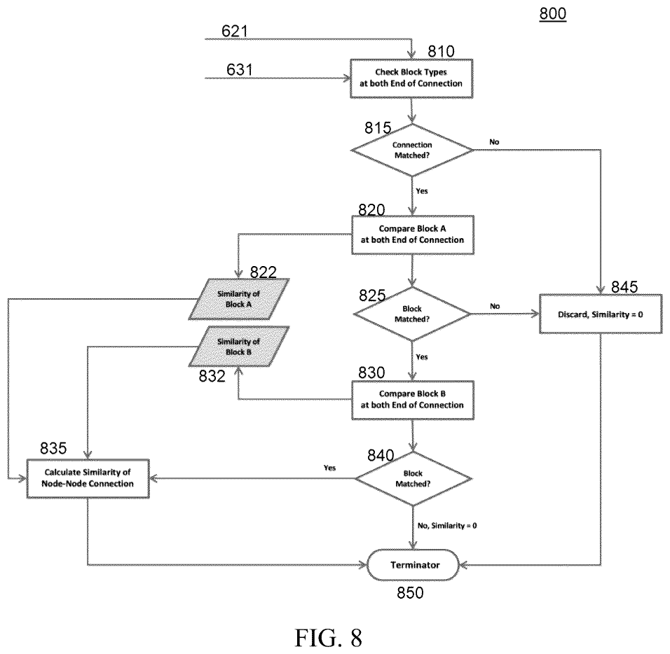

As illustrated in FIG. 3, the program code classifies document images and determines possible document types by comparing and evaluating the distance between the document and templates in a knowledge graph database (315). In some embodiments of the present invention, the program code can compare a document image to multiple templates in a knowledge graph database in parallel. This parallel processing can enable system scalability and enhance system performance. FIG. 5 is a workflow of this parallel processing comparison aspect. FIGS. 6-8 provide additional details beyond certain generalities illustrated in FIG. 5. FIG. 6 includes details of block information for blocks 610 compared in these figures as well as portions of graphs (generated by the program code) for both a runtime document graph 630 and a template graph 620, which are referred to as edges and are compared in FIG. 8. In FIG. 8, the program code compares an edge 621 of the template graph 620 to an edge 631 of a runtime graph 631. A runtime graph refers to a graph-like structure generated on-the-fly by the program code so that the program code can compare the document (which is the basis of the runtime graph) to graph structures of templates stored in a database.

In FIG. 5, program code (that can be understood as a document image graph builder 540) executing on one or more processors generates a graph 542 (like the graph-like structure 400 of FIG. 4). The program code compares the graph of the document 542 to various graph templates 592a, 592b, 592x. In this example, the parallel processing of these comparisons is handled by three separate machines 593a, 593b, 593c, however, in other embodiments, fewer or more machines can be utilized and the parallel processing can also be accomplished by multi-threading in a single or more than one processor. For each comparison, the aspects can be similar, but in FIG. 5, the comparison of the document graph 542 is illustrated in more detail. Given that the processing can be in parallel, the same steps can be executed synchronously and/or asynchronously when comparing the document to each template.

The program code obtains data both from a template graph 592a and the graph 542 generated by the program code from the document. The program code sorts the template graph 592a and moves to a document, the next document, for comparison 546. When comparing the document graph 542 to the template graph 592a (and other template graphs), the program code searches the graphs for similarities 544. The program code locates and calculates the connection similarities (e.g., distances) 552 and determines whether the elements match 554. The program code can temporarily store, as temporary data 556, the element matches. If the elements do not match, the program code can move to the next element 546. Based on the temporary data 556. The program code can calculate a graph similarity 558 between the template 592a and the document. In the parallel processing (or in sequence), the program code can also, in the same manner, calculate a graph similarity 562 between a different template 592b and the document. The program code can compare 564 the resultant similarities 558, 562. The program code can determine a matched template 592x (or a group of most closely matching templates) based on these comparisons.

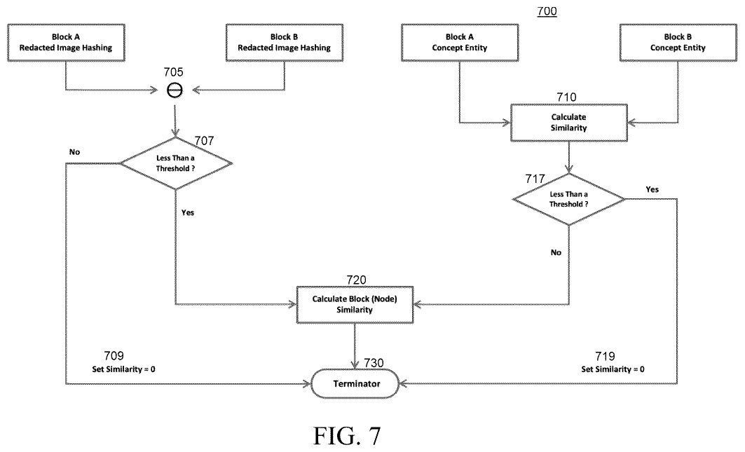

FIG. 7 illustrates a workflow 700 of how, as part of comparing a graph of the document to various graph templates, the program code calculates node similarities between the document and one or more templates. FIG. 7 illustrates the program code calculating similarities between a Block A and a Block B (blocks from the document as compared to blocks in the template). The block information 430 of FIG. 4 is an example of the block information of Block A in FIG. 7. FIG. 7 illustrates the program code comparing a redacted image hashtag from Block A to a redacted image hashtag from Block B as well as a concept entity from Block A to a concept entity from Block B. As explained above, the program code not only compares graphical elements (e.g., blocks) in a document image, but also contextual information from the document image and the template. Thus, the program code identifies similarities in both appearance and content of nodes to determine whether a template matches a document.

The program code compares a redacted image hashtag from Block A to a redacted image hashtag from Block B (705) to determine whether the distance between the elements is less than a threshold (707). If the distance is less than a threshold, the program code calculates the node similarity (720). In parallel or sequentially, the program code calculates a similarity between a concept entity from Block A to a concept entity from Block B (710). If the distance is not less than a threshold, the program code terminates the process (730). The program code determines if the similarity is less than a threshold (717). If the similarity is not less than a threshold, the program code calculates the node similarity (720). If the similarity is less than a threshold (717), the process terminates (730). When the distance is greater than or equal to the threshold and/or the similarity is less than a threshold, the program code can set the similarity to 0 before terminating the process (709, 719). For the blocks that comprise a document image, the program code attempts to match the blocks, in content and format, to a template. The two equations below represent the matching.

$${S}_{Block} = \frac{{\sum }_{i = 0}^{1} f ( block )}{2} \\ f ( x ) = \{ \begin{matrix}1 & block matched \\ 0 & block not matched\end{matrix}$$

FIG. 8 illustrates a workflow 800 in which program code calculates edge similarities. The edges being compared by the program code in this example, to calculate the similarity, are the edges 621, 631 from FIG. 6. The edges are connections between elements in the document images (the runtime document image and the template). The program code checks the block types at the end of each edge (e.g., connection) (810). The program code determines if the connections are matched (e.g., 621, 631) (815). If the connection matches, the program code compares Block A at the end of the connection (820). The program code calculates the similarity for Block A (822). The program code determines if the block matched the template (825). The program code compares Block B at the end of the connection (830). The program code determines whether the blocks match (840). The program code generates a similarity for Block B (832). The program code calculates the similarity of the node-node connection using the similarities of A and B (835) (which can be based, in part, by determining whether the blocks match (840)). When the connection and/or the blocks do not match, the program code discards the similarity (or rather, the lack thereof) 845. The program code terminates the process (850) after calculating the edge similarities (835) or determining that there are no matches and discarding the edges (845).

The equations below represent the edge similarities determined by the program code in the workflow 800 of FIG. 8.

$${S}_{connection} = \frac{{S}_{Block A} + {S}_{Block B}}{2} \\ S = Similarity Value$$

Once the program code matches a template to a document, the program code can calculate a confidence value to represent the confidence of the match. On can calculate the confidence score as f=Σᵢ₌₀ⁿWiSi+b where Wᵢ is a weight of a node of type i, Sᵢ is a similarity value of a node type i, and b is a similarity value of a first stage.

As discussed herein, the document to template matching process described herein processes documents by breaking each document into component pieces based on the layout (structural) of the page (e.g., text, table, stamp, signature, barcode, figures etc.). The program code extracts the named entities and concepts in every component of the page. Based on pre-defined rules, the program code extracts meaningless components or entities or concepts based on predefined rules. The predefined rules can specify that the program code redacts certain types of objects, including but not limited to, stamps on the page, numeric values in tables etc. The program code constructs new graph based on the redacted page and connection relationship of the layout of page. The program code compares this new graph with base templates in a graph database. In this manner, the program code utilizes knowledge graph database technology to store the structural information of documents, the fingerprints of fields (visual information), concepts (textual information) of component block and methods of processing each block. In embodiments of the present invention, the program code comprising the graph builder can automatically or semi-automatically construct a preliminary knowledge graph from requirement documents and/or am end-user's input, but the program code can continue to learn through repetition of this process and thus, discover more synonymous concepts from public domains and help to improve the accuracy of the graph-building.

Embodiments of the present invention include computer-implemented methods, computer program products, and computer systems of improving template matching in a document-image, where program code, executing on one or more processors, merges a document comprising multiple pages into a single document image. The program code processes the single document image to identify structural elements and textual content comprising the structural elements. The program code compares the structural elements of the single document image to other structural elements of a group of document templates stored in a database and based on the comparing, identifying a subset of the group of documents templates with a threshold number of similarities to the single document image. The program code generates, from the single document image, a graph structure representing the document, where the graph structure comprises visual information and connections related to the structural elements and concepts comprising the textual content. The program code identifies, based on comparing the graph structure to the subset of the group of documents templates, a document template that is a closest match to the document.

In some examples, the program code generates, from the group of document templates stored in the database, a graph structure for each template, where the identifying comprises comparing the graph structure for each template in the subset of the group of document templates to the graph structure.

In some examples, the program code processing the document image to identify the structural elements and the textual content comprising the structural elements comprises the program code performing optical character recognition to identify text and block segments and layout types.

In some examples, the structural elements of the single document image utilized in the comparing are selected from the group consisting of: an image hashing of the single document image, a block type, a quantity of the block type, a title of the document, and a heading of the document.

In some examples, the program code generating the graph structure representing the document comprises: the program code processing layout blocks comprising the single document image. The generating also comprises the program code redacting specific types of text based on pre-defined business rules. The generating can also include the program code generating the graph structure, where the graph structure does not comprise the redacted text.

In some examples, the program code processing the layout blocks comprises: the program code recognizing, named entities comprising the layout blocks, the program code extracting concepts in text comprising the layout blocks, the program code connecting the layout blocks based on position of each layout block in the single document image, and the program code calculating fingerprints for the layout blocks.

In some examples, the visual information of the graph structure comprises fingerprints of the blocks, where the connections related to the structural elements comprise the connections of the layout blocks based on the positions, and the concepts comprise the extracted concept in the text comprising the layout blocks.

In some examples, the fingerprints comprise image hashing of the layout blocks.

In some examples, the program code comparing the structural elements of the single document image to other structural elements of the group of document templates stored in the database comprises the program code simultaneously comparing the structural elements of the single document image to at least structural elements of at least two document templates of the group of document templates.

In some examples, the document template that is the closest match to the document is the closest match based on visual similarities between the single document image and the document template that is the closest match and content similarities between the single document image and the document template that is the closest match.

In some examples, the program code comparing the structural elements of the single document image to other structural elements of the group of document templates stored in a database comprises the program code utilizing an image hash algorithm to determine a distance between the single document image and each template of the group of document templates.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of improving template matching in a document-image, the method comprising:
merging, by one or more processors, a document comprising multiple pages into a single document image;
processing, by the one or more processors, the single document image to identify structural elements and textual content comprising the structural elements;
comparing, by the one or more processors, the structural elements of the single document image to other structural elements of a group of document templates stored in a database and based on the comparing, identifying a subset of the group of documents templates with a threshold number of similarities to the single document image;
generating, by the one or more processors, from the single document image, a graph structure representing the document, wherein the graph structure comprises visual information and connections related to the structural elements and concepts comprising the textual content; and
identifying, by the one or more processors, based on comparing the graph structure to the subset of the group of documents templates, a document template that is a closest match to the document.

2. The computer-implemented method of claim 1, further comprising:
generating, by the one or more processors, from the group of document templates stored in the database, a graph structure for each template, wherein the identifying comprises comparing the graph structure for each template in the subset of the group of document templates to the graph structure.

3. The computer-implemented method of claim 1, wherein processing the document image to identify the structural elements and the textual content comprising the structural elements comprises performing optical character recognition to identify text and block segments and layout types.

4. The computer-implemented method of claim 1, wherein the structural elements of the single document image utilized in the comparing are selected from the group consisting of:
an image hashing of the single document image, a block type, a quantity of the block type, a title of the document, and a heading of the document.

5. The computer-implemented method of claim 1, wherein generating the graph structure representing the document, comprises:
processing, by the one or more processors, layout blocks comprising the single document image;
redacting, by the one or more processors, specific types of text based on pre-defined business rules; and
generating, by the one or more processors, the graph structure, wherein the graph structure does not comprise the redacted text.

6. The computer-implemented method of claim 5, wherein processing the layout blocks comprises:
recognizing, by the one or more processors, named entities comprising the layout blocks;
extracting, by the one or more processors, concepts in text comprising the layout blocks;
connecting, by the one or more processors, the layout blocks based on position of each layout block in the single document image; and
calculating, by the one or more processors, fingerprints for the layout blocks.

7. The computer-implemented method of claim 6, wherein the visual information of the graph structure comprises fingerprints of the blocks, wherein the connections related to the structural elements comprise the connections of the layout blocks based on the positions, and the concepts comprise the extracted concept in the text comprising the layout blocks.

8. The computer-implemented method of claim 7, wherein the fingerprints comprise image hashing of the layout blocks.

9. The computer-implemented method of claim 1, wherein comparing the structural elements of the single document image to other structural elements of the group of document templates stored in the database comprises simultaneously comparing the structural elements of the single document image to at least structural elements of at least two document templates of the group of document templates.

10. The computer-implemented method of claim 1, wherein the document template that is the closest match to the document is the closest match based on visual similarities between the single document image and the document template that is the closest match and content similarities between the single document image and the document template that is the closest match.

11. The computer-implemented method of claim 1, wherein comparing the structural elements of the single document image to other structural elements of the group of document templates stored in a database comprises utilizing an image hash algorithm to determine a distance between the single document image and each template of the group of document templates.

12. A computer system for improving template matching in a document-image, the computer system comprising:
a memory; and
one or more processors in communication with the memory, wherein the computer system is configured to perform a method, said method comprising:
merging, by the one or more processors, a document comprising multiple pages into a single document image;
processing, by the one or more processors, the single document image to identify structural elements and textual content comprising the structural elements;
comparing, by the one or more processors, the structural elements of the single document image to other structural elements of a group of document templates stored in a database and based on the comparing, identifying a subset of the group of documents templates with a threshold number of similarities to the single document image;
generating, by the one or more processors, from the single document image, a graph structure representing the document, wherein the graph structure comprises visual information and connections related to the structural elements and concepts comprising the textual content; and
identifying, by the one or more processors, based on comparing the graph structure to the subset of the group of documents templates, a document template that is a closest match to the document.

13. The computer system of claim 12, the method further comprising:
generating, by the one or more processors, from the group of document templates stored in the database, a graph structure for each template, wherein the identifying comprises comparing the graph structure for each template in the subset of the group of document templates to the graph structure.

14. The computer system of claim 12, wherein processing the document image to identify the structural elements and the textual content comprising the structural elements comprises performing optical character recognition to identify text and block segments and layout types.

15. The computer system of claim 12, wherein the structural elements of the single document image utilized in the comparing are selected from the group consisting of: an image hashing of the single document image, a block type, a quantity of the block type, a title of the document, and a heading of the document.

16. The computer system of claim 12, wherein generating the graph structure representing the document, comprises:
processing, by the one or more processors, layout blocks comprising the single document image;
redacting, by the one or more processors, specific types of text based on pre-defined business rules; and
generating, by the one or more processors, the graph structure, wherein the graph structure does not comprise the redacted text.

17. The computer system of claim 16, wherein processing the layout blocks comprises:
recognizing, by the one or more processors, named entities comprising the layout blocks;
extracting, by the one or more processors, concepts in text comprising the layout blocks;
connecting, by the one or more processors, the layout blocks based on position of each layout block in the single document image; and
calculating, by the one or more processors, fingerprints for the layout blocks.

18. The computer system of claim 17, wherein the visual information of the graph structure comprises fingerprints of the blocks, wherein the connections related to the structural elements comprise the connections of the layout blocks based on the positions, and the concepts comprise the extracted concept in the text comprising the layout blocks.

19. The computer system of claim 18, wherein the fingerprints comprise image hashing of the layout blocks.

20. A computer program product for improving template matching in a document-image, the computer program product comprising:
one or more computer readable storage media and program instructions collectively stored on the one or more computer readable storage media readable by at least one processing circuit to perform a method comprising:
merging, by the one or more processors, a document comprising multiple pages into a single document image;
processing, by the one or more processors, the document image to identify structural elements and textual content comprising the structural elements;
comparing, by the one or more processors, the structural elements of the single document image to structural elements of a group of document templates stored in a database and based on the comparing, identifying a subset of the group of documents templates with a threshold number of similarities to the single document image;
generating, by the one or more processors, from the single document image, a graph structure representing the document, wherein the graph structure comprises visual information and connections related to the structural elements and concepts comprising the textual content; and
identifying, by the one or more processors, based on comparing the graph structure to the subset of the group of documents templates, a document template that is a closest match to the document.
